(19) United States
(12) Patent Application Publication
(10) Pub. No.: US 2009/0187747 A1
(43) Pub. Date: Jul. 23, 2009

(54) SYSTEM AND METHOD FOR TRACING INSTRUCTION POINTERS AND DATA ACCESS

(75) Inventors: Albrecht Mayer, Deisenhofen (DE); Harry Siebert, Puchheim (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: INFINEON TECHNOLOGIES AG, Neubiberg (DE)

(21) Appl. No.: 12/016,347

(22) Filed: Jan. 18, 2008

(51) Int. Cl. G06F 9/44

(52) U.S. Cl. 712/227

(57) ABSTRACT

A system and method for tracing instruction pointers and data access is disclosed. In one embodiment the system includes a plurality of trace units including at least one first trace unit configured to perform an instruction pointer trace, and at least one second trace unit configured to perform a data trace. A multiplexer is connected between the plurality of processor cores and the plurality of trace units.

### BACKGROUND

The invention relates to methods and systems for debugging software running on a plurality of microprocessor cores embedded in a system on chip. In one embodiment, the invention relates to methods and systems for enabling retrieval and trace, respectively, of operations of microprocessor cores and associated busses.

For software debugging in an embedded application a trace flow is useful to determine which kind of events had taken place before a particular software problem arose. In general, a trace unit enables reconstruction of a monitored program flow. For these purposes a trace unit records trace data which is information about the running embedded application without halting its execution and stores the trace data sequentially, i.e. information about executed instructions is stored in the sequence of their execution.

A trace unit may record values of the instruction pointer (program counter) of a microprocessor and/or may record data accessed and processed, respectively, by a processor and/or the data flow on processor busses.

An instruction pointer (program counter) is a register in a computer processor which indicates where the computer is in its instruction sequence. Depending on the type of microprocessor, the instruction pointer includes either the address of the instruction being executed or the address of the next address to be executed.

In general, the instruction pointer is automatically incremented for each instruction cycle so that instructions are normally retrieved sequentially from memory. However, certain instructions, such as branches and subroutine calls and returns, interrupt the sequence by placing a new value in the instruction pointer.

When tracing the instruction pointer, a trace unit continually receives messages including compressed program flow information. Provided that the program flow is linear, a respective message includes the number of executed linear program steps. If there is a branch in the program flow, the message will indicate a branch and, if required, the (relative) destination address of the branch.

Accordingly, the trace unit will receive about 2 bits of data per instruction which, depending on the clock rate of the traced processor, will amount to at least 100 MByte of trace data per second, roughly estimated.

For a trace of data accesses, compression is very limited. Thus, the trace unit will receive about 7 Bytes per access which, depending on the clock rate of the traced processor, will amount to several hundreds of MByte of trace data per second, roughly estimated.

Consequently, as the computing power and clock rate of modern processors increases more and more, also the amount of recorded trace data will further increase which involves very complex and die area consuming trace units, as, for example, a very large buffer memory or a high performance interface is required for managing this huge trace data volume.

For modern systems on chip (SoC) including several processor cores, this problem gets worse as the trace data volume naturally increases with the number of processor cores. Known SoCs include for example one trace unit for each processor core. However, the plurality of trace units together with an on-chip buffer memory demands a significant part of the chip area.

Therefore, there exists a need for a system and a method for tracing instruction pointers and/or data accesses in a plurality of processor cores.

### SUMMARY

In one embodiment, there is provided a system for tracing instruction pointers and data accesses in a plurality of processor cores, the system including: a plurality of trace units including at least one first trace unit configured to perform an instruction pointer trace, and at least one second trace unit configured to perform a data trace; and a multiplexer connected between the plurality of processor cores and the plurality of trace units.

Further features, aspects and advantages of the present invention will become apparent from the following detailed description of the invention made with reference to the accompanying drawings.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 illustrates an exemplary schematic diagram of a system according to one embodiment.

FIG. 2 illustrates an exemplary schematic diagram of a system according to one embodiment.

FIG. 3 illustrates an exemplary schematic diagram of a system according to one embodiment.

FIG. 4 illustrates an exemplary schematic diagram of a system according to one embodiment.

FIG. 5 illustrates a schematic simplified flowchart illustrating a method for tracing instruction pointers and data flow in a plurality of processor cores in accordance with one embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

For software debugging in an embedded application a trace flow is useful to determine which kind of events had taken place before a particular software problem arose. In general, a trace unit enables reconstruction of a monitored program flow. For these purposes a trace unit records trace data which is information about the running embedded application without halting its execution and stores the trace data sequentially, i.e. information about executed instructions is stored in the sequence of their execution.

A trace unit may record values of the instruction pointer (program counter) of a microprocessor core and/or may record data accessed and processed, respectively, by a processor and/or the data flow on processor busses.

An instruction pointer (program counter) is a register in a computer processor core which indicates where the computer is in its instruction sequence. Depending on the type of microprocessor, the instruction pointer includes either the address of the instruction being executed or the address of the next address to be executed.

In general, the instruction pointer is automatically incremented for each instruction cycle so that instructions are normally retrieved sequentially from memory. However, certain instructions, such as branches and subroutine calls and returns, interrupt the sequence by placing a new value in the instruction pointer.

When tracing the instruction pointer, a trace unit continually receives messages including compressed program flow information. Provided that the program flow is linear, a respective message includes the number of executed linear program steps. If there is a branch in the program flow, the message will indicate a branch and, if required, the (relative) destination address of the branch.

Accordingly, the trace unit will receive about 2 bits of data per instruction which, depending on the clock rate of the traced processor core, will amount to at least 100 MByte of trace data per second, roughly estimated.

For a trace of data accesses, compression is very limited. Thus, the trace unit will receive about 7 Bytes per access which, depending on the clock rate of the traced processor core, will amount to several hundreds of MByte of trace data per second, roughly estimated.

For modern systems on chip (SoC) including several processor cores the trace data volume additionally increases with the number of processor cores.

Further, the trace unit may provide time stamps for the trace data to facilitate study of the trace data. Accordingly, messages originating from an instruction pointer trace or data trace include an associated time stamp including a time of occurrence.

Furthermore, trigger events are generally used when carrying out traces, wherein a trigger event may be an access to a certain address or also a certain data value, for example. A trigger event may initiate a certain action, such as e.g., starting a debug monitoring or pausing operation of a processor core, or triggers may be used to control the trace flow itself.

For instance, the a trigger may be used to define a trace length providing a criterion for stopping the trace or may also be used to qualify a trace which means the trace is only activated if certain prerequisites are met, such as e.g., the instruction pointer is within a certain instruction sequence of a program.

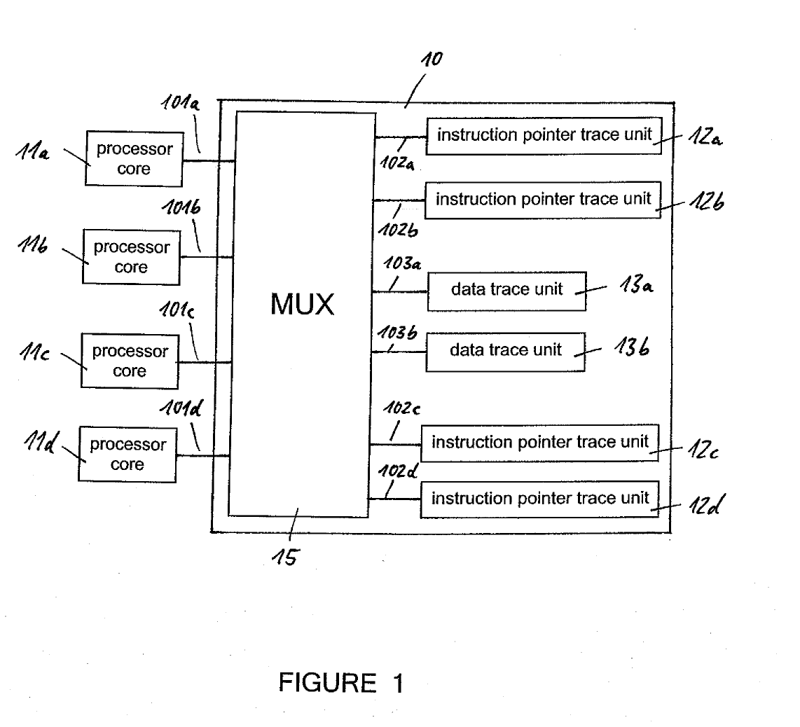

FIG. 1 illustrates a schematic diagram of a system according to one embodiment, wherein the system 10 is connected to a plurality of processor cores 11a, 11b, 11c, 11d.

The system 10 includes a multiplexer 15 and a plurality of trace units 12 and 13 including a plurality of instruction pointer trace units 12a, 12b, 12c, 12d, and a plurality of data trace units 13a, 13b. The instruction pointer trace units 12a, 12b, 12c, 12d are connected to the multiplexer 15 via connections 102a, 102b, 102c, 102d, respectively, and the data trace units 13a, 13b are connected to the multiplexer 15 via connections 103a, 103b, respectively. The plurality of processor cores 11a, 11b, 11c, 11d are connected to the system 10, or rather to the multiplexer 15, via connections 101a, 101b, 101c, 101d.

For performing a trace of one of the processor cores 11a, 11b, 11c, 11d any of the trace units 12 and 13 may be selected and assigned to the one processor core by using the multiplexer 15. Generally, any of the trace units 12 and 13 can be assigned, i.e. connected, to any of the processor cores 11a, 11b, 11c, 11d. Thus, trace units can be selected according to their feature to trace a certain processor core.

For example, when a instruction pointer trace of processor core 11a is intended, instruction pointer trace unit 12a may be connected to the processor core 11a via the multiplexer 15. As a further example, for a data trace of processor core 11d, data trace unit 13b may be connected to the processor core 11d via the multiplexer 15.

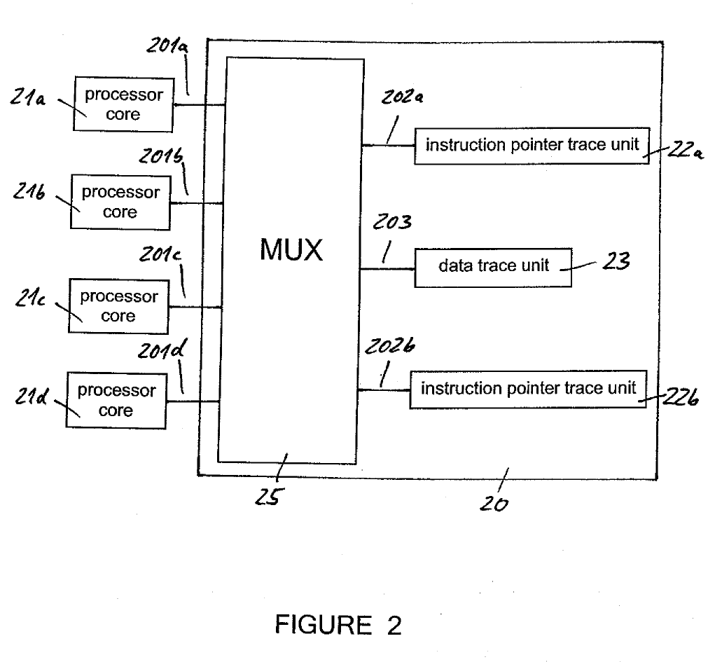

In the embodiment of FIG. 1, there are as many instruction pointer trace units 12a, 12b, 12c, 12d present as processor core units are connected to the system 10. Therefore, all processor cores may be monitored in parallel by the plurality of instruction pointer trace units 12a, 12b, 12c, 12d, i.e. for example, four instruction pointer traces may be performed simultaneously. However, other embodiments with less instruction pointer trace units than processor cores connected to the exemplary system are also possible as exemplarily illustrated in FIG. 2.

FIG. 2 illustrates a schematic diagram of a system according to one embodiment. As mentioned above, the embodiment illustrated in FIG. 2 is similar to the one of FIG. 1, but include less trace units. Reducing the number of trace units is often appropriate as thereby, die area required for the trace units can significantly be reduced which reduces production costs and as it is sufficient for many applications only to trace e.g., one or two processor cores at a time.

The system 20 includes a multiplexer 25 and a plurality of trace units 22 and 23 including a plurality of instruction pointer trace units 22a, 22b and a data trace unit 23. The instruction pointer trace units 22a, 22b are connected to the multiplexer 15 via connections 202a, 202b, respectively, and the data trace unit 23 is connected to the multiplexer 25 via connection 203. The plurality of processor cores 21a, 21b, 21c, 21d are connected to the system 20, or rather to the multiplexer 25, via connections 201a, 201b, 201c, 201d, respectively.

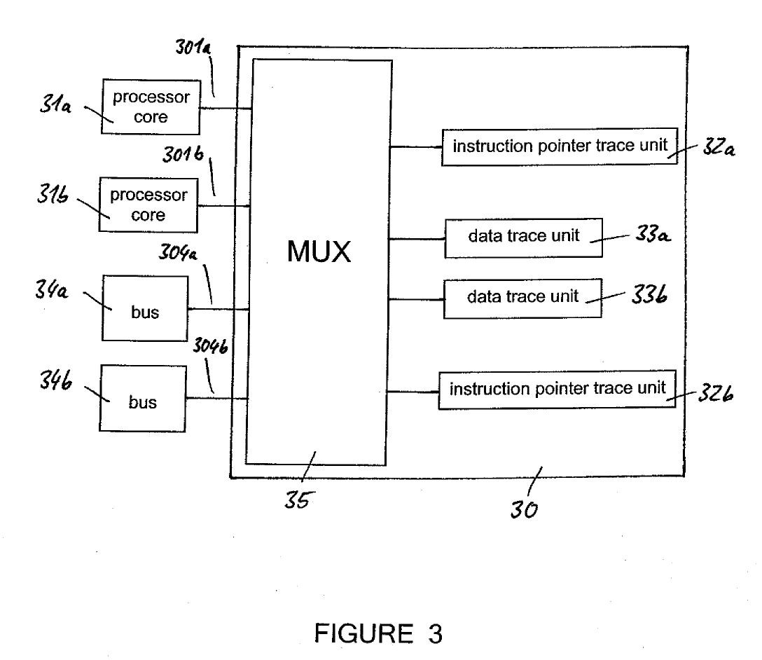

FIG. 3 illustrates a schematic diagram of a system according to one embodiment, wherein the system 30 is connected to a plurality of processor cores 31a, 31b and to a plurality of busses 34a, 34b.

The system 30 includes a multiplexer 35 and a plurality of trace units 32 and 33 including a plurality of instruction pointer trace units 32a, 32b and a plurality of data trace units 33a, 33b. The instruction pointer trace units 32a, 32b are connected to the multiplexer 35 via connections 302a, 302b, respectively, and the data trace units 33a, 33b are connected to the multiplexer 35 via connections 303a, 303b. The plurality of busses 34a, 34b are connected to the system 30, or rather to the multiplexer 35, via connections 304a, 304b, and the plurality of processor cores 31a, 31b are connected to the multiplexer 35 via connections 301a, 301b.

In this embodiment, additionally to processor core traces (which are carried out along the lines of operations illustrated for the systems of FIGS. 1 and 2), also data transfers on the busses 34a, 34b may be traced. For example, when a data trace of bus 34a is intended, data trace unit 33a may be connected to the bus 34a via the multiplexer 35.

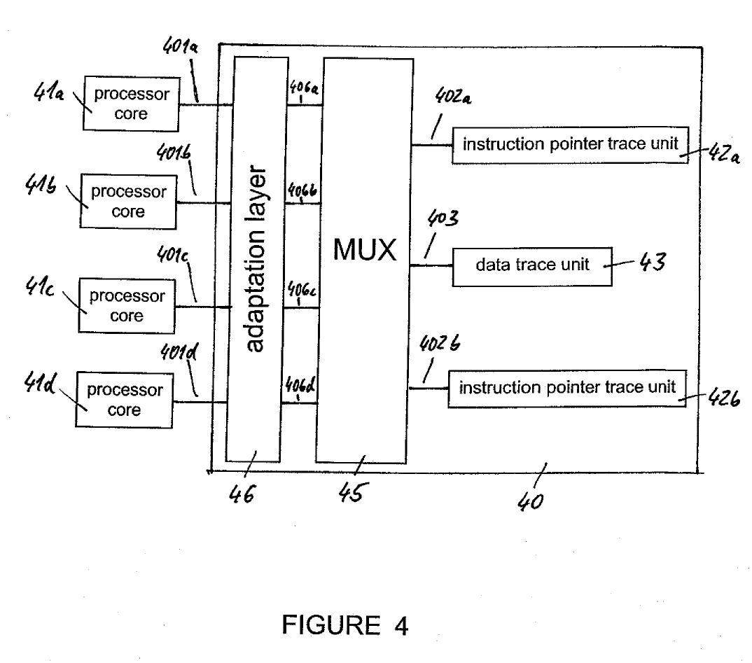

FIG. 4 illustrates a schematic diagram of a system according to one embodiment, wherein the system 40 is connected to a plurality of processor cores 41a, 41b, 41c, 41d of different types.

The system 40 of FIG. 4 includes the same structure as the one of FIG. 2: The system 40 also includes a multiplexer 45 and a plurality of trace units 42 and 43 including a plurality of instruction pointer trace units 42a, 42b and a data trace unit 43. However, the system 40 additionally includes an adaptation layer 46 connected between the plurality of processor cores 41a, 41b, 41c, 41d and the multiplexer 45.

The instruction trace units 42a, 42b are connected to the multiplexer 45 via connections 402a, 402b, respectively, and the data trace unit 43 is connected to the multiplexer 45 via connection 403. The plurality of processor cores 41a, 41b, 41c, 41d are connected to the system 40, or in this case to the adaptation layer 46, via connections 401a, 401b, 401c, 401d, respectively, and the adaptation layer 46 is connected to the multiplexer 45 via connections 406a, 406b, 406c, 406d.

The adaptation layer 46 provides a feasibility to use one trace unit for multiple processor cores of different types. Thus, system 40 can be implemented in systems on chip including processor cores of different types. Instead of providing a dedicated trace unit for each type of processor cores, the system 40 provides the adaptation layer 46 which standardizes the trace data outputs of the respective processor cores. In that way, similar to the system of FIGS. 1 and 2, any trace unit of the plurality of trace units 42, 43 can be assigned and connected, respectively, to any processor core of the plurality of processor cores 41a, 41b, 41c, 41d.

One example for a standardization of the trace data outputs may be a separation of the trace data in address information data and associated data including executed instruction units.

In case the processor cores have clock rates different from the clock rates of the respective trace units, a clock rate or frequency adaptation may be carried out by the adaptation layer. For embodiments not including an adaptation layer (see e.g., FIGS. 1 and 2) means configured to adapt the frequency of the trace data outputs of the processor cores may be connected between the processor cores and the multiplexer.

As the chronological succession of the trace data may be interrupted due to differing clock rate and the adaptation thereof, time stamps may be used to specify a time of occurrence of the respective trace data.

In one embodiment, the allocation of trace units to processor cores and busses via the multiplexer may be changed dynamically, i.e. if a specific condition is met the allocation of a trace core unit may be changed, for example from one processor core to another one. The dynamic assignment change may also be controlled by certain trigger events.

In one embodiment, for use in symmetrical multi-processor architectures multiple trace units having different computing power may virtually be assigned to respective processor cores. To test the core software of several processor cores of a plurality of identical cores having one shared memory, it is not mandatory to actually carry out the trace on a certain core. Instead, logical cores on which the respective core software runs are specified. Thus, when a single trace unit is to be used to sequentially test the software running on several logical cores the change of the allocation of the single trace unit is done by logically exchanging the cores. Therefore, not all processor cores have to be (physically) connected to the trace units as one core which is physically connected to the trace unit(s) can be mapped to different logical cores for different trace performance.

In one embodiment, the plurality of trace units may be in an own power domain. As this power domain may be switched off when not in use power consumption may be decreased which is of particular interest in battery powered devices like mobile phones. Further, a low threshold voltage design can be used for the transistors of the trace units, as resulting increased leakage currents can be tolerated since the trace units are in an own power domain.

The embodiments described above may be implemented in a system on a chip (SoC). However, this implementation is optional and not mandatory.

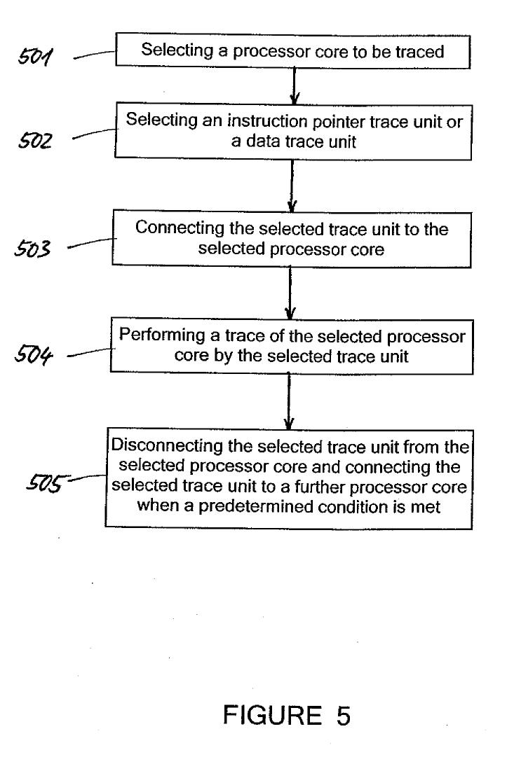

FIG. 5 illustrates a schematic simplified flowchart illustrating a method for tracing instruction pointers and data flow in a plurality of processor cores in accordance with one embodiment.

At 501, a processor core to be traced is selected and, at 502 an instruction pointer trace unit or a data trace unit is selected.

Then, at 503, the selected (instruction pointer or data) trace unit is connected to the selected processor core by a multiplexer.

At 504, a (instruction pointer or data) trace of the selected processor core is performed by the selected (instruction pointer or data) trace unit.

Then, at 505, the selected trace unit may assigned to another processor core if, for example, a predetermined condition is met, e.g., a certain trigger event occurs. In other words, for example, when a certain trigger event occurs the selected trace unit is disconnected from the selected processor core and connected to a further processor core.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A system for tracing instruction pointers and data accesses in a plurality of processor cores, the system comprising:
a plurality of trace units comprising:
at least one first trace unit configured to perform an instruction pointer trace, and
at least one second trace unit configured to perform a data trace; and
a multiplexer coupled between the plurality of processor cores and the plurality of trace units.

2. The system of claim 1, comprising wherein at least one of the at least one first trace unit and the at least one second trace unit are less in number than the plurality of processor cores.

3. The system of claim 1, comprising wherein the multiplexer is configured to selectively connect one trace unit of the plurality of trace units to one processor core of the plurality of processor cores.

4. The system of claim 3, comprising wherein the multiplexer is further configured to disconnect the one trace unit from the one processor core and to connect the one trace unit to a further processor core of the plurality of processor cores.

5. The system of claim 3, comprising wherein the multiplexer is further configured to disconnect the one trace unit from the one processor core and to connect the one trace unit to a further processor core of the plurality of processor cores when a predetermined condition is met.

6. The system of claim 1, comprising an adaptation layer connected between the plurality of processor cores and the multiplexer, wherein the adaptation layer is configured to match the clock rate of a selected processor core of the plurality of processor cores and the clock rate of a selected trace unit of the plurality of trace units.

7. The system of claim 6, comprising wherein the adaptation layer is configured to standardize data obtained from the plurality of processor cores.

8. The system of claim 7, comprising wherein the adaptation layer is configured to standardize data obtained from the plurality of processor cores by separating the obtained data in address information data and information data comprising executed instruction units.

9. A system for tracing instruction pointers and data accesses in a plurality of processor cores of different types, the system comprising:
a plurality of trace units comprising:
at least one first trace unit configured to perform an instruction pointer trace, and
at least one second trace unit configured to perform a data trace;
a multiplexer; and
an adaptation layer,
wherein the adaptation layer is coupled to the plurality of processor cores and the multiplexer and the multiplexer is coupled to the plurality of trace units.

10. The system of claim 9, comprising wherein at least one of the at least one first trace unit and the at least one second trace unit are less in number than the plurality of processor cores.

11. The system of claim 10, comprising wherein the multiplexer is configured to selectively connect one trace unit of the plurality of trace units to one processor core of the plurality of processor cores.

12. The system of claim 11, comprising wherein the multiplexer is configured to disconnect the one trace unit from the one processor core and to connect the one trace unit to a further processor core of the plurality of processor cores.

13. The system of claim 11, comprising wherein the multiplexer is configured to disconnect the one trace unit from the one processor core and to connect the one trace unit to a further processor core of the plurality of processor cores when a predetermined condition is met.

14. The system of claim 9, comprising wherein the adaptation layer is configured to standardize data obtained from the plurality of processor cores of different types.

15. The system of claim 9, comprising wherein the adaptation layer is configured to standardize data obtained from the plurality of processor cores of different types by separating the obtained data in address information data and information data comprising executed instruction units.

16. The system of claim 15, comprising wherein the adaptation layer is configured to perform a frequency adaptation between different frequencies of the plurality of processor cores and of the plurality of trace units.

17. A system on chip comprising:
a plurality of processor cores;
a plurality of busses;
a plurality of trace units comprising:
at least one first trace unit configured to perform an instruction pointer trace, and
at least one second trace unit configured to perform a data trace; and
a multiplexer connected between the plurality of processor cores and the plurality of trace units.

18. The system of claim 17, comprising wherein the multiplexer is configured to selectively connect one of the plurality of trace units to one of the pluralities of processor cores and busses.

19. The system of claim 17, comprising wherein the plurality of trace units are assigned to a power domain separated from one or more other power domains of the system on chip.

20. The system of claim 19, comprising wherein the plurality of trace units comprise transistors with a low threshold voltage.

21. A method comprising:
selecting a processor core to be traced from a plurality of processor cores;
selecting a trace unit from a plurality of trace units comprising at least one instruction pointer trace unit and at least one data trace unit;
connecting the selected trace unit to the selected processor core via a multiplexer;
performing a trace of the selected processor core by the selected trace unit.

22. The method of claim 21, further comprising:
disconnecting the selected trace unit from the selected processor core; and
connecting the selected trace unit to a further processor core of the plurality of processor cores.

23. The method of claim 21, further comprising:
disconnecting the selected trace unit from the selected processor core; and
connecting the selected trace unit to a further processor core of the plurality of processor cores when a predetermined condition is met.
